(19) United States
(12) Patent Application Publication
(10) Pub. No.: US 2017/0345381 A1
(43) Pub. Date: Nov. 30, 2017

(54) DISPLAY APPARATUS AND DYNAMIC VOLTAGE CONTROLLER

(71) Applicant: Raydium Semiconductor Corporation, Hsinchu (TW)

(72) Inventors: Chun-Lin Hou, Hsinchu City (TW); Chien-Lin Huang, Hsinchu City (TW); Shao-Ping Hung, Hsinchu City (TW)

(21) Appl. No.: 15/599,675

(22) Filed: May 19, 2017

Related U.S. Application Data
(60) Provisional application No. 62/342,226, filed on May 27, 2016.

(51) Int. Cl. G09G 3/34; G09G 3/3225; G09G 3/00; G09G 3/3275; G09G 3/20

(52) U.S. Cl. CPC G09G 3/3406; G09G 3/3275; G09G 3/2011; G09G 3/006; G09G 3/3225; G09G 2310/08; G09G 2340/0407

(57) ABSTRACT

A dynamic voltage controller applied to a display apparatus is disclosed. The display apparatus includes a display panel and a power supply. The power supply is coupled to the display panel. The dynamic voltage controller includes a data analyzing module and a voltage control module. The data analyzing module receives and analyzes an image data to obtain a maximum brightness, an average brightness and an average current to further estimate a minimum driving voltage needed for the display panel to display the image data. The voltage control module coupled between the data analyzing module and power supply is used to output a voltage control signal to the power supply according to the minimum driving voltage, so that the power supply is controlled by the voltage control signal to output the minimum driving voltage to the display panel to drive the display panel to display the image data.

### BACKGROUND OF THE INVENTION

### 1. Field of the Invention

This invention relates to a display, especially to a display apparatus and a dynamic voltage controller.

### 2. Description of the Prior Art

In recent years, the organic light-emitting diode (OLED) display panel has been widely used in various kinds of display apparatus. In general, the total power consumption of the OLED display panel includes the power consumption of the driving IC and the power consumption of the light-emitting components. Especially, the light-emitting components of the OLED display panel have much more power consumption than the driving IC. Therefore, it is an important issue to reduce the power consumption of the light-emitting components.

Conventionally, a single frame image data is detected to obtain its peak value and then a maximum driving voltage ΔVDMAX needed for the OLED display panel to display the image data according to the detected peak value, so that the redundant power consumption caused by the additional driving voltages ΔV1 and ΔV2 out of the maximum driving voltage ΔVDMAX can be avoided, as shown in FIG. 1.

However, only the peak value of a single frame image data is used to estimate the maximum driving voltage ΔVDMAX in the prior art; that is to say, the maximum driving voltage ΔVDMAX is the voltage needed for the display panel to display the single frame image data having all bright regions BR (as shown in FIG. 2A) including the IR rise IRR and the IR drop IRD caused by the maximum driving current needed for displaying maximum lightness.

In practical applications, as shown in FIG. 2B, only a small part of the single frame image data is the bright region BR and other parts of the single frame image data are dark regions DR. At this time, the driving current passing through the OLED display panel displaying only a small bright region BR will be much smaller than the driving current passing through the OLED display panel displaying all bright region BR, and the IR rise and the IR drop caused by the driving current passing through the OLED display panel displaying only the small bright region BR will be much smaller than the IR rise and the IR drop caused by the driving current passing through the OLED display panel displaying all bright region BR.

Therefore, under the condition of only considering the peak value of the single frame image data, the IR rise, the IR drop and the maximum driving voltage will be estimated too large and unnecessary power consumption will be used by the conventional display apparatus.

### SUMMARY OF THE INVENTION

Therefore, the invention provides a display apparatus and a dynamic voltage controller to solve the above-mentioned problems in the prior arts.

An embodiment of the invention is a dynamic voltage controller. In this embodiment, the dynamic voltage controller is applied to a display apparatus. The display apparatus includes a display panel and a power supply. The power supply is coupled to the display panel. The dynamic voltage controller includes a data analyzing module and a voltage control module. The data analyzing module is used for receiving an image data and analyzing the image data to obtain a maximum brightness, an average brightness and an average current corresponding to the image data to further estimate a minimum driving voltage needed for the display panel to display the image data. The voltage control module is coupled between the data analyzing module and the power supply and used for outputting a voltage control signal to the power supply according to the minimum driving voltage to control the power supply to output the minimum driving voltage to the display panel to drive the display panel to display the image data.

In an embodiment, the display panel is an OLED display panel.

In an embodiment, the dynamic voltage controller further includes a look-up table storing a correspondence between the average brightness and the average current corresponding to the image data and the minimum driving voltage needed for the display panel to display the image, wherein when the data analyzing module obtains the average brightness and the average current corresponding to the image data, the data analyzing module estimates the minimum driving voltage needed for the display panel to display the image data according to the look-up table.

In an embodiment, the power supply outputs a first voltage and a second voltage to the display panel respectively, and the minimum driving voltage is a difference between the first voltage and the second voltage.

In an embodiment, the data analyzing module includes a peak value detecting unit and a calculating unit. The peak value detecting unit is used for detecting the maximum brightness of the image data. The calculating unit is used for calculating the average brightness and the average current of the image data.

In an embodiment, the display apparatus further includes a data processor. The data processor is coupled to the dynamic voltage controller and used for providing the image data to the dynamic voltage controller.

Another embodiment of the invention is a display apparatus. In this embodiment, the display apparatus includes a display panel, a dynamic voltage controller and a power supply. The dynamic voltage controller includes a data analyzing module and a voltage control module. The data analyzing module is used for receiving an image data and analyzing the image data to obtain a maximum brightness, an average brightness and an average current corresponding to the image data to further estimate a minimum driving voltage needed for the display panel to display the image data. The voltage control module is coupled to the data analyzing module and used for outputting a voltage control signal according to the minimum driving voltage. The power supply is coupled between the voltage control module and the display panel and used for outputting the minimum driving voltage to the display panel according to the voltage control signal to drive the display panel to display the image data.

Compared to the prior art, the display apparatus and dynamic voltage controller of the invention use the currently displayed image data or lightness adjusted image data to estimate corresponding average lightness and average current needed for the display panel to display the image data to set the driving voltage needed for the display panel; therefore, the IR rise, the IR drop and the driving voltage needed will not be estimated too large in the invention to reduce power consumption.

The advantage and spirit of the invention may be understood by the following detailed descriptions together with the appended drawings.

### BRIEF DESCRIPTION OF THE APPENDED DRAWINGS

FIG. 1 illustrates a schematic diagram of calculating the maximum driving voltage needed for the OLED display panel according to the peak value of a single frame to save power consumption caused by additional driving voltage in the prior art.

FIG. 2A illustrates a schematic diagram of the single frame having all bright regions.

FIG. 2B illustrates a schematic diagram that only a small part of the single frame is the bright region and other parts of the single frame are dark regions.

FIG. 3 illustrates a functional block diagram of the display apparatus in a preferred embodiment of the invention.

FIG. 4A illustrates a functional block diagram of the dynamic voltage controller in another preferred embodiment of the invention.

FIG. 4B illustrates a functional block diagram of the data analyzing module including the peak value detecting unit and the calculating unit.

FIG. 5 illustrates a schematic diagram that the minimum driving voltage ΔVDMIN used in the invention can save more power consumption than the maximum driving voltage ΔVDMAX used in the prior art.

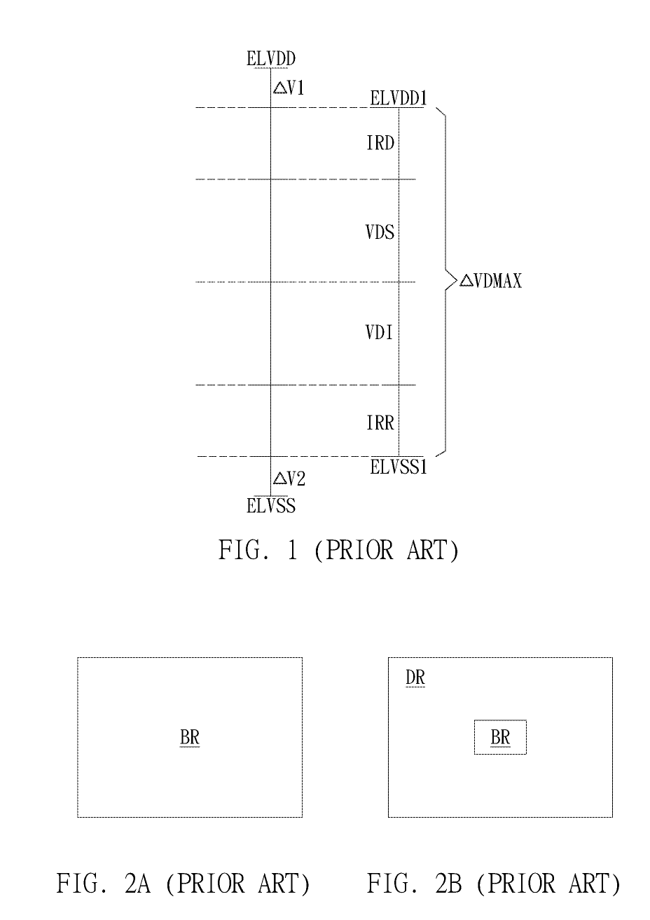

### DETAILED DESCRIPTION OF THE INVENTION

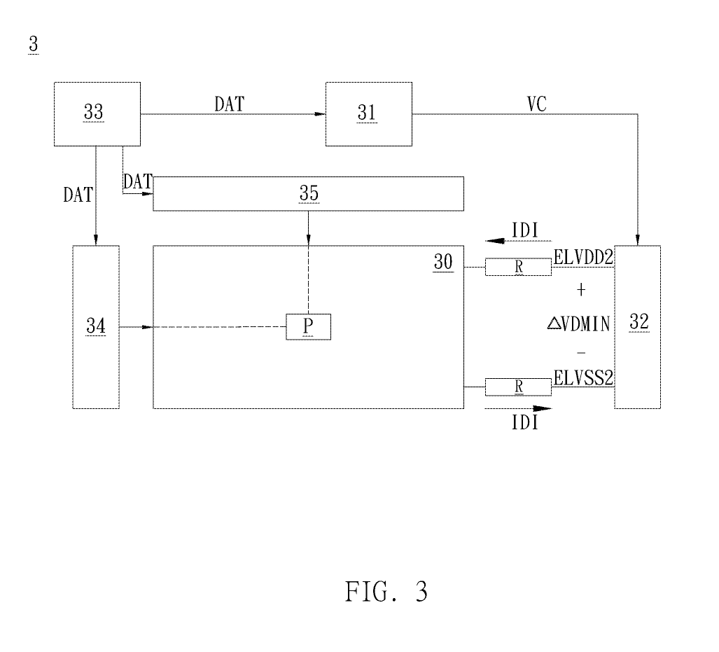

A preferred embodiment of the invention is a display apparatus. In this embodiment, an OLED display panel is used in the display apparatus, but not limited to this. At first, please refer to FIG. 3. FIG. 3 illustrates a functional block diagram of the display apparatus in this embodiment.

As shown in FIG. 3, the display apparatus 3 includes a display panel 30, a dynamic voltage controller 31, a power supply 32, a data processor 33 and data drivers 34˜35. Wherein, the display panel 30 includes a plurality of pixels P; the data processor 33 is coupled to the dynamic voltage controller 31 and the data drivers 34˜35 respectively; the dynamic voltage controller 31 is coupled to the power supply 32; the power supply 32 is coupled to the display panel 30 through the resistor; the data driver 34 is coupled to the pixels P on the display panel 30 along the horizontal direction; the data driver 35 is coupled to the pixels P on the display panel 30 along the vertical direction.

After the data processor 33 receives the image data DAT and performs image processing on the image data DAT, the data processor 33 will output the processed image data DAT to the dynamic voltage controller 31 and the data drivers 34˜35 respectively. When the dynamic voltage controller 31 receives the image data DAT, the dynamic voltage controller 31 will output a voltage control signal VC to the power supply 32 according to the image data DAT. When the power supply 32 receives the voltage control signal VC, the power supply 32 will output the minimum driving voltage ΔVDMIN to the display panel 30 according to the voltage control signal VC to drive the display panel 30 to display the image data DAT.

It should be noticed that, as shown in FIG. 3, the power supply 32 has two output terminals coupled to the display panel 30 through the resistor R respectively. When the power supply 32 outputs the minimum driving voltage ΔVDMIN to the display panel 30, voltage levels of the two output terminals of the power supply 32 are a first voltage ELVDD2 and a second voltage ELVSS2 respectively. Wherein, the first voltage ELVDD2 will form a diode current IDI flowing from the power supply 32 to the display panel 30, when the diode current IDI flows through the resistor R, a IR drop (e.g., IRD′ in FIG. 5) will be generated and the IR drop will be equal to the product of the diode current IDI and the resistance of the resistor R; the second voltage ELVSS2 will form a diode current IDI flowing from the display panel 30 to the power supply 32, when the diode current IDI flows through the resistor R, a IR rise (e.g., IRR′ in FIG. 5) will be generated and the IR rise will be equal to the product of the diode current IDI and the resistance of the resistor R.

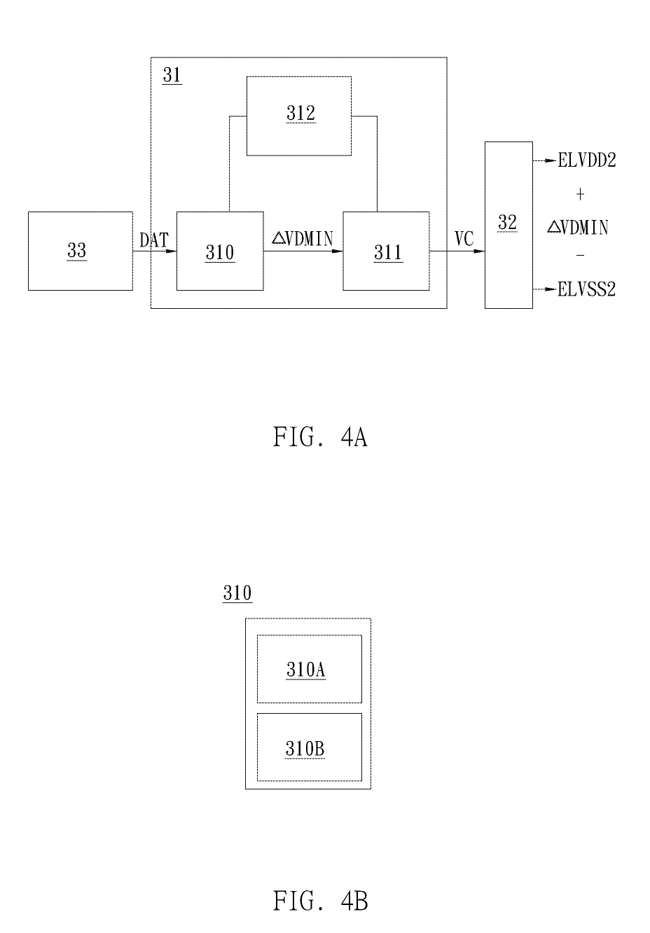

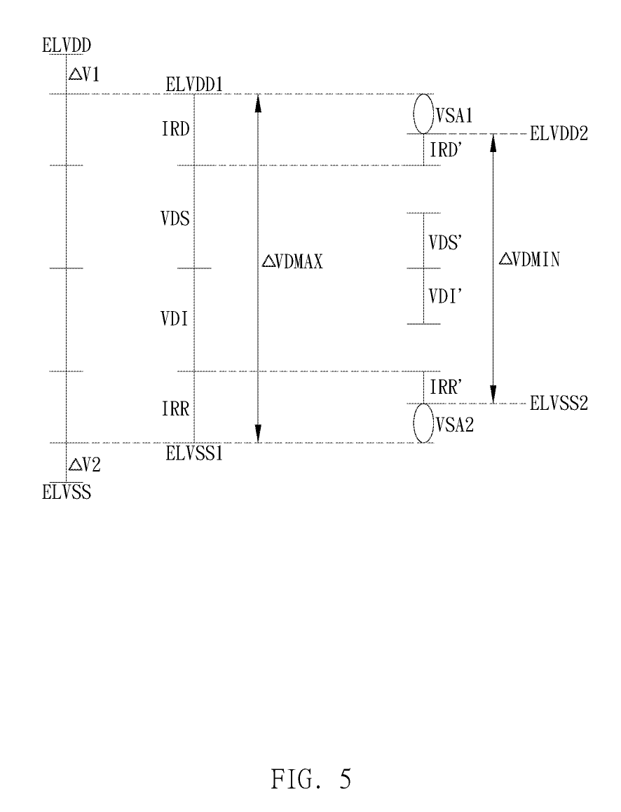

Then, please refer to FIG. 4A. FIG. 4A illustrates a functional block diagram of the dynamic voltage controller 31. As shown in FIG. 4A, the dynamic voltage controller 31 includes a data analyzing module 310, a voltage control module 311 and a look-up table 312. Wherein, the data analyzing module 310 is coupled between the data processor 33 and the voltage control module 311; the voltage control module 311 is coupled between the data analyzing module 310 and the power supply 32; the look-up table 312 is coupled between the data analyzing module 310 and the voltage control module 311.

In this embodiment, when the data analyzing module 310 receives the image data DAT transmitted from the data processor 33, the data analyzing module 310 will analyze the image data DAT to obtain a maximum brightness, an average brightness and an average current corresponding to the image data DAT to further estimate the minimum driving voltage ΔVDMIN needed for the display panel 30 to display the image data DAT and then output the minimum driving voltage ΔVDMIN to the voltage control module 311. Then, the voltage control module 311 will output the voltage control signal VC to the power supply 32 according to the minimum driving voltage ΔVDMIN to control the power supply 32 to output the minimum driving voltage ΔVDMIN to the display panel 30, so that the display panel 30 will be driven by the minimum driving voltage ΔVDMIN to display the image data DAT.

In an embodiment, as shown in FIG. 4B, the data analyzing module 310 can include a peak value detecting unit 310A and a calculating unit 310B. Wherein, the peak value detecting unit 310A is used for detecting the maximum brightness of the image data DAT; the calculating unit 310B is used for calculating the average brightness and the average current of the image data DAT.

Then, please refer to FIG. 5. FIG. 5 illustrates a schematic diagram that the minimum driving voltage ΔVDMIN used in the invention can save more power consumption than the maximum driving voltage ΔVDMAX used in the prior art.

As shown in FIG. 5, the IR drop in the prior art is IRD and the IR drop in the invention is IRD′, and both of them equal to the product of the diode current IDI and the resistance of the resistor R; however, the diode current IDI used in the prior art is “the maximum driving current” needed for the display panel to display the pixel having “the maximum lightness”, while the diode current IDI used in the invention is “the average driving current” needed for the display panel to display the pixel having “the average lightness”. Since “the average driving current” is usually smaller than “the maximum driving current”, the IR drop IRD′ in the invention will be smaller than the IR drop IRD in the prior art, and the voltage difference VSA1 between the IR drop IRD in the prior art and the IR drop IRD′ in the invention is the voltage saved by the invention. Therefore, the invention can be not only closer to the actual displaying situation of the display panel 30, but also effectively reduce the unnecessary power consumption in the prior art.

Similarly, the IR rise in the prior art is IRR and the IR rise in the invention is IRR′, and both of them equal to the product of the diode current IDI and the resistance of the resistor R; however, the diode current IDI used in the prior art is “the maximum driving current” needed for the display panel to display the pixel having “the maximum lightness”, while the diode current IDI used in the invention is “the average driving current” needed for the display panel to display the pixel having “the average lightness”. Since “the average driving current” is usually smaller than “the maximum driving current”, the IR rise IRR′ in the invention will be smaller than the IR rise IRR in the prior art, and the voltage difference VSA2 between the IR rise IRR in the prior art and the IR rise IRR′ in the invention is the voltage saved by the invention. Therefore, the invention can be not only closer to the actual displaying situation of the display panel 30, but also effectively reduce the unnecessary power consumption in the prior art.

It should be also noticed that, as shown in FIG. 5, the display voltage VDS' and the diode voltage VDI′ of the invention may be also smaller than the display voltage VDS and the diode voltage VDI of the prior art; however, since it is possible for the display panel 30 to display the pixel having “the maximum lightness” in practical applications, the voltage range of the original display voltage and diode voltage used in the prior art will be also used in the invention.

Therefore, the minimum driving voltage ΔVDMIN needed for the display panel 30 to display the image data DAT obtained by the data analyzing module 310 will be equal to the sum of the IR drop IRD′, the display voltage VDS, the diode voltage VDI and the IR rise IRR′ and smaller than the maximum driving voltage ΔVDMAX used in the prior art. Compared to the maximum driving voltage ΔVDMAX used in the prior art, the voltage saved by the minimum driving voltage ΔVDMIN used in the invention will be equal to the sum of the voltage differences VSA1 and VSA2 shown in FIG. 5.

Compared to the prior art, the display apparatus and dynamic voltage controller of the invention use the currently displayed image data or lightness adjusted image data to estimate corresponding average lightness and average current needed for the display panel to display the image data to set the driving voltage needed for the display panel; therefore, the IR rise, the IR drop and the driving voltage needed will not be estimated too large in the invention to reduce power consumption.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A dynamic voltage controller, applied to a display apparatus, the display apparatus comprising a display panel and a power supply, the power supply being coupled to the display panel, the dynamic voltage controller comprising:
a data analyzing module for receiving an image data and analyzing the image data to obtain a maximum brightness, an average brightness and an average current corresponding to the image data to further estimate a minimum driving voltage needed for the display panel to display the image data; and
a voltage control module, coupled between the data analyzing module and the power supply, for outputting a voltage control signal to the power supply according to the minimum driving voltage to control the power supply to output the minimum driving voltage to the display panel to drive the display panel to display the image data.

2. The dynamic voltage controller of claim 1, wherein the display panel is an OLED display panel.

3. The dynamic voltage controller of claim 1, further comprises a look-up table storing a correspondence between the average brightness and the average current corresponding to the image data and the minimum driving voltage needed for the display panel to display the image, wherein when the data analyzing module obtains the average brightness and the average current corresponding to the image data, the data analyzing module estimates the minimum driving voltage needed for the display panel to display the image data according to the look-up table.

4. The dynamic voltage controller of claim 1, wherein the power supply outputs a first voltage and a second voltage to the display panel respectively, and the minimum driving voltage is a difference between the first voltage and the second voltage.

5. The dynamic voltage controller of claim 1, wherein the data analyzing module comprises:
a peak value detecting unit, for detecting the maximum brightness of the image data; and
a calculating unit, for calculating the average brightness and the average current of the image data.

6. The dynamic voltage controller of claim 1, wherein the display apparatus further comprises:
a data processor, coupled to the dynamic voltage controller, for providing the image data to the dynamic voltage controller.

7. A display apparatus, comprising:
a display panel;
a dynamic voltage controller, comprising:
a data analyzing module for receiving an image data and analyzing the image data to obtain a maximum brightness, an average brightness and an average current corresponding to the image data to further estimate a minimum driving voltage needed for the display panel to display the image data; and
a voltage control module, coupled to the data analyzing module, for outputting a voltage control signal according to the minimum driving voltage; and
a power supply, coupled between the voltage control module and the display panel, for outputting the minimum driving voltage to the display panel according to the voltage control signal to drive the display panel to display the image data.

8. The display apparatus of claim 7, wherein the display panel is an OLED display panel.

9. The display apparatus of claim 7, wherein the dynamic voltage controller further comprises a look-up table storing a correspondence between the average brightness and the average current corresponding to the image data and the minimum driving voltage needed for the display panel to display the image, when the data analyzing module obtains the average brightness and the average current corresponding to the image data, the data analyzing module estimates the minimum driving voltage needed for the display panel to display the image data according to the look-up table.

10. The display apparatus of claim 7, wherein the power supply outputs a first voltage and a second voltage to the display panel respectively, and the minimum driving voltage is a difference between the first voltage and the second voltage.

11. The display apparatus of claim 7, wherein the data analyzing module comprises:
a peak value detecting unit, for detecting the maximum brightness of the image data; and
a calculating unit, for calculating the average brightness and the average current of the image data.

12. The display apparatus of claim 7, further comprising:
a data processor, coupled to the dynamic voltage controller, for providing the image data to the dynamic voltage controller.
